(19) United States
(12) Patent Application Publication
(10) Pub. No.: US 2022/0321317 A1
(43) Pub. Date: Oct. 6, 2022

(54) TIME DIVISION DUPLEX SCHEDULING

(71) Applicant: AT&T Intellectual Property I, L.P., Atlanta, GA (US)

(72) Inventors: Stewart Barker, Bulverde, TX (US); Bhushan Padhiar, Frisco, TX (US)

(73) Assignee: AT&T Intellectual Property I, L.P., Atlanta, GA (US)

(21) Appl. No.: 17/221,902

(22) Filed: Apr. 5, 2021

(51) Int. Cl. H04L 5/14; H04B 3/50

(52) U.S. Cl. CPC H04L 5/1469; H04L 5/1438; H04B 3/50

(57) ABSTRACT

Aspects of the subject disclosure may include, for example, determining that speed test has been requested, and modifying data traffic on a time division duplex transmission medium in response. The modifying may include a scheduler modifying a ratio of uplink data packets to downlink data packets. The time duplex transmission medium may include twisted pairs of wires or a wireless medium. Other embodiments are disclosed.

### FIELD OF THE DISCLOSURE

The subject disclosure relates to scheduling in time division duplex systems.

### BACKGROUND

Time Division Duplexing (TDD) on 5G/LTE air interface and unshielded twisted pair transmission media uses shared channel technique for uplink and downlink traffic which makes it difficult to get symmetric speed performance. The uplink and downlink bandwidth depends on the total aggregate bandwidth available on the channel. With this limitation, service providers find it difficult to offer symmetric speed tiers to broadband and mobility customers.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a network communication device providing broadband service to a dwelling in accordance with various aspects described herein.

FIG. 2B is a block diagram illustrating an example, non-limiting embodiment of a network communication device in accordance with various aspects described herein.

FIG. 2C is a block diagram illustrating an example, non-limiting embodiment of communication frames and subframes in accordance with various aspects described herein.

FIG. 2D is a table illustrating an example, non-limiting embodiment of ratios of uplink packets and downlink packets in accordance with various aspects described herein.

FIG. 2E is a block diagram illustrating an example, non-limiting embodiment of a network communication device providing broadband service to a multi-dwelling building in accordance with various aspects described herein.

FIGS. 2F and 2G depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for scheduling in time division duplex systems. Other embodiments are described in the subject disclosure.

One or more aspects of the subject disclosure include a processing system including a processor and a memory that stores executable instructions that, when executed by the processing system, facilitate performance of operations. The operations may include monitoring data traffic on a transmission medium, in response to the monitoring, determining that a speed test has been requested, and in response to the determining that the speed test has been requested, modifying a ratio of upload packets on the transmission medium to download packets on the transmission medium for a predetermined period of time to ensure a minimum upload speed is achieved. Additional aspects may include the transmission medium being a twisted pair of wires or being a first twisted pair of wires in a plurality of twisted pairs of wires, shielded or unshielded. Further additional aspects may include modifying data traffic on at least one of plurality of the twisted pairs of wires other than the first twisted pair of wires during the predetermined period of time to reduce signal interference between the at least one of the plurality of the twisted pairs of wires and the first twisted pairs of wires.

One or more aspects of the subject disclosure include a non-transitory machine-readable medium, comprising executable instructions that, when executed by a processing system including a processor, facilitate performance of operations. The operations may include monitoring data traffic on a transmission medium, in response to the monitoring, determining that a speed test has been requested, and in response to the determining that the speed test has been requested modifying a ratio of upload packets on the transmission medium to download packets on the transmission medium for a predetermined period of time to ensure a minimum upload speed is achieved.

One or more aspects of the subject disclosure include A method comprising monitoring, by a processing system including a processor, data traffic on a transmission medium, in response to the monitoring, determining, by the processing system, that a speed test has been requested, and in response to the determining that the speed test has been requested, modifying, by the processing system, a ratio of upload packets on the transmission medium to download packets on the transmission medium for a predetermined period of time to ensure a minimum upload speed is achieved.

Further aspects of the disclosure include a method comprising swinging sub-frame assignments of time division duplex (TDD) splits to dynamically modify a ratio of uplink data packets and downlink data packets with short spacing gap and short reaction time between two symbols by assigning a time scheduler to frames. The method may include providing manual management of the time scheduler handling by assigning a predetermined time to uplink TDD symbols to achieve symmetric uplink and downlink speeds, and the time scheduler may allow symbols to achieve a desired uplink speed for a predetermined period of time based on a user data traffic transaction. In still further aspects, the method may return the ratio of uplink data packets to downlink data packets to a value that existed prior to the assigning the time scheduler to the frames, wherein the further modifying is performed after the predetermined period of time, and wherein the predetermined period of time is specified by an operator via an application programming interface (API).

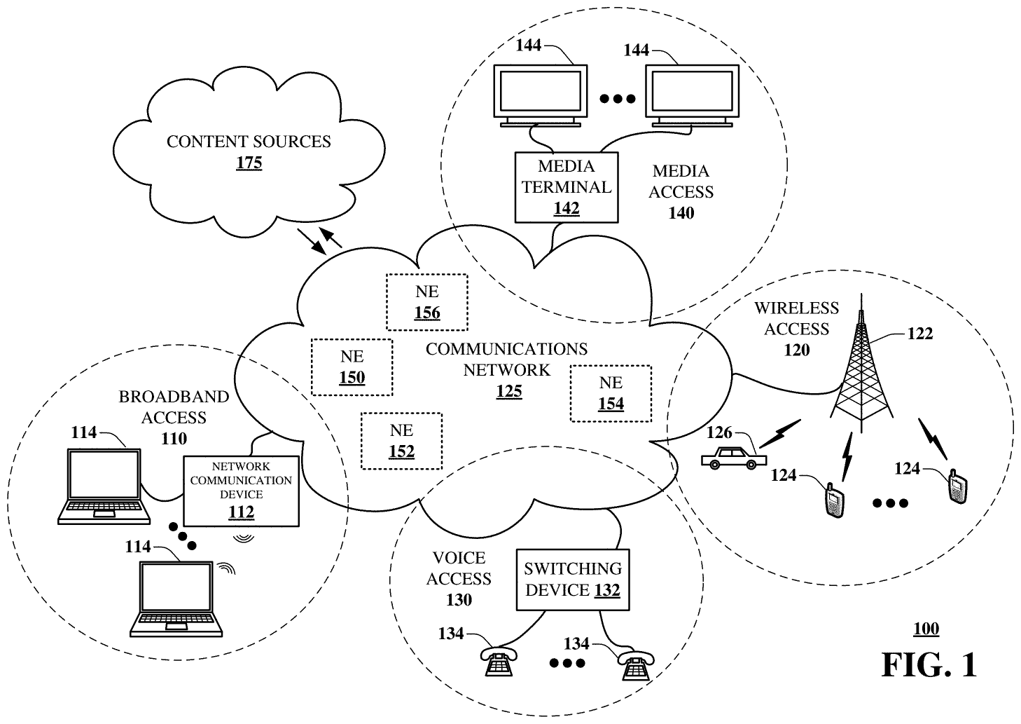

Referring now to FIG. 1, a block diagram is shown illustrating an example, non-limiting embodiment of a system 100 in accordance with various aspects described herein. For example, system 100 can facilitate in whole or in part modifying ratios of upload packets to download packets in response to request for a speed test. In particular, a communications network 125 is presented for providing broadband access 110 to a plurality of data terminals 114 via network communication device 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the network communication device 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

Various embodiments described herein provide a technique to modify subframe assignments of TDD splits which can dynamically move the ratio of uplink and downlink with very short spacing gap and minimum reaction time between two symbols by assigning a time scheduler to the frames. This allows downlink symbols to swing very low, thereby boosting the uplink symbols up and vice versa depending on the traffic pattern. These and other mechanisms described herein allow customers to experience symmetric uplink and downlink speeds. In some embodiments the mechanisms that allow customers to experience symmetric uplink and downlink speeds are employed when a customer action satisfies a trigger, such as requesting a speed test.

In some embodiments, the durations of symbol bursts are recorded and priority is given to new bursts as user traffic patterns change for limited intervals of time. Short bursts may improve customer experience when swinging the uplink and downlink data rate capacity. In some embodiments, priority is given to short bursts depending on the traffic.

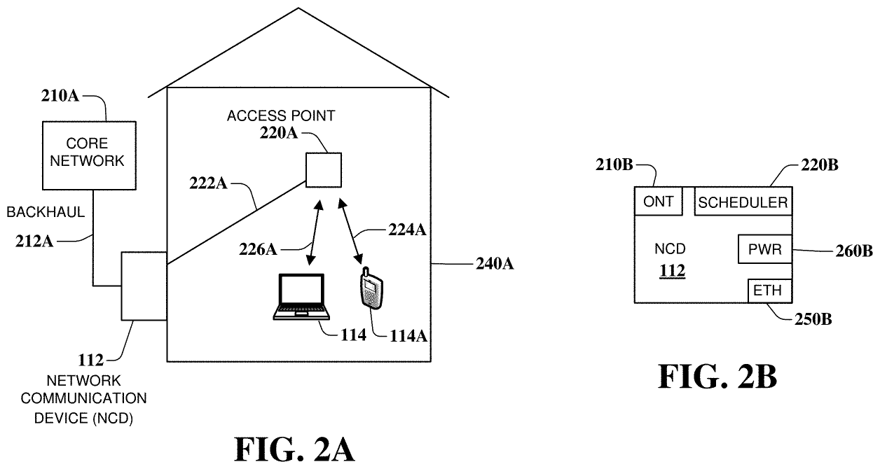

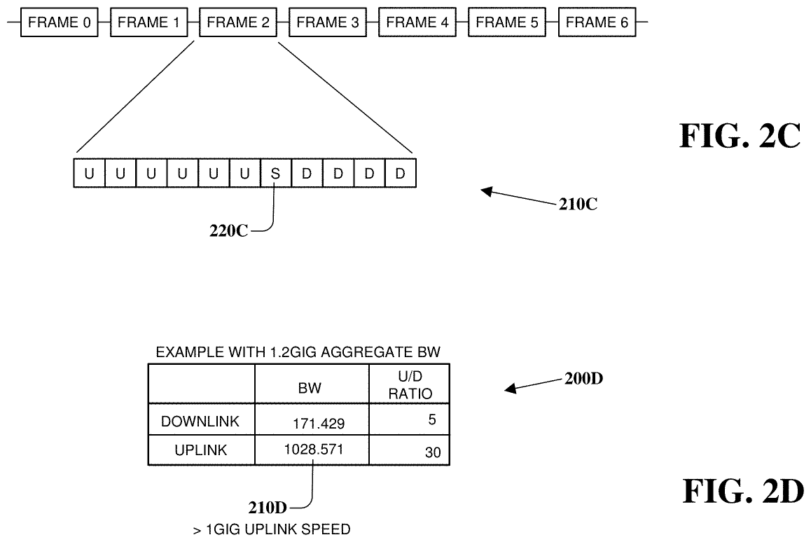

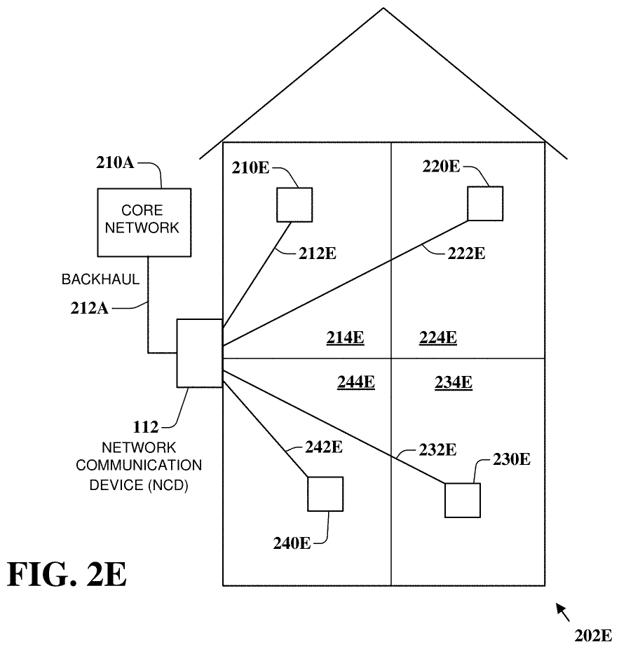

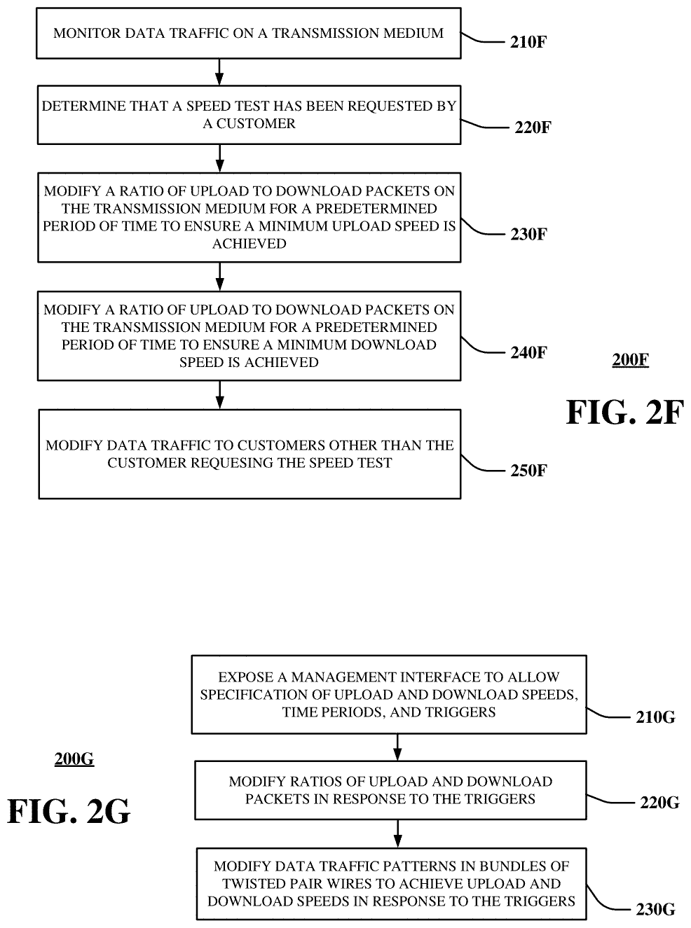

FIG. 2A is a block diagram illustrating an example, non-limiting embodiment of a network communication device providing broadband service to a dwelling in accordance with various aspects described herein. Network communication device 112 is shown on the outside of a dwelling 240A. Network communication device 112 connects to a core network 210A via a backhaul link 212A and provides broadband access to the interior of dwelling 240A. For example, a wired link 222A is shown connecting network communication device 112 to access point 220A. In some embodiments, network communication device 112 provides broadband services to one or more devices associated with a user account of a broadband customer. For example, a data terminal (e.g., laptop computer) such as data terminal 114 and or user equipment 114A may associate to access point 220A and receive broadband services from NCD 112 relayed over the wired link 222A.

Wired link 222A may be any type of transmission medium. For example, wired link 222A may include one or more twisted pairs of wires to carry data. Also for example, wired link 222A may include shielded twisted pairs of wires or unshielded twisted pairs of wires. In still further embodiments, wired link 222A may be a twisted pair of wires that is included in a bundle that includes a plurality of shielded or unshielded twisted pairs of wires. As used herein, the terms “twisted pairs” and “twisted pairs of wires” are used interchangeably.

As used herein, “broadband services” refers to services typically associated with internet access services provided to dwellings. For example, broadband services may be provided by a fixed wireline cable or fiber to a dwelling, and may be governed by a contract between a service provider and a consumer providing a minimum or maximum data rate. An example may include a cable terminating at a residential gateway with minimum or maximum data rates of 25 megabits per second (Mbps), 100 Mbps, 1000 Mbps, or any other data rate. Another example may include an optical fiber to a dwelling, an optical network terminal (ONT), and a residential gateway with minimum or maximum data rates of 25 Mbps, 100 Mbps, 1000 Mbps or any other data rate.

The service provider may maintain user accounts associated with broadband customers. User accounts associated with broadband customers may maintain any information pertinent to the broadband customer or the account of the broadband customer. For example, a broadband customer user account may include billing information, site location, data rates, permissions related to broadband service, and the like.

In some embodiments, a customer may perform a speed test to verify that the customer is receiving broadband data rates specified in the customer's contract with the service provider. For example, a customer may use data terminal 114 to access a website that performs an uplink speed test and a downlink speed test and reports data rates accordingly. In some embodiments, this includes a website or service that is managed by the service provider, and in other embodiments, this includes a website or service that is managed by an entity that is distinct from the entity that provides the communication services including broadband access.

In some embodiments, network communication device 112 modifies its behavior when a customer performs a speed test to ensure that the contracted minimum uplink data rates and downlink rates are shown in the speed test results. For example, if wired link 222A is a time division duplex (TDD) transmission medium such as a twisted pair of wires, network communication device 112 may modify a ratio of uplink packets to downlink packets for a predetermined period of time in response to determining that a user is requesting a speed test. Further, in some embodiments, network communication device 112 may perform other actions such as modifying data traffic on other twisted pairs of wires in a bundle to reduce crosstalk and ensure that the customer sees minimum contracted uplink data rates and downlink data rates.

In some embodiments, network communication device 112 may have access to a customer profile that includes information such as minimum contracted uplink data rates and downlink data rates. In some embodiments, at least a portion of the information in the customer profile may be specified through a management interface exposed to an entity that has permission to modify customer details. For example, a web interface may be provided to a manager within the service provider's organization or any other organization to allow the manager to specify minimum uplink data rates, minimum downlink data rates, and the like. Also for example, the management interface may allow a manager to specify an action that will trigger the modification of data traffic as well as an amount of time that data traffic may be altered in response to the trigger. One particular example of a trigger may be accessing a speed test website, and a predetermined period of time may be three seconds, five seconds, or any other amount of time.

Continuing with the above example, in operation, a customer may request a speed test, and network communication device 112 may recognize that a speed test has been requested. In response, network communication device 112 may access the customers user profile, determine that a speed test is specified as a trigger, and then proceed to modify uplink and downlink packet ratios for a predetermined period of time that is specified in the customer's profile in order to ensure that the customer sees the minimum contracted uplink data rates and downlink data rates. In some embodiments, the time period may be dynamic such as at least an amount long enough to satisfy the minimum contracted uplink data rates and downlink data rates but also longer based on other factors, such as network conditions, QoS information for the subscriber, current services being accessed by the subscriber, etc. These and other embodiments are described further below.

FIG. 2B is a block diagram illustrating an example, non-limiting embodiment of a network communication device in accordance with various aspects described herein. As shown in FIG. 2B, network communication device 112 includes a backhaul link circuit such as optical network terminal 210B. This backhaul link circuit is provided as an example, and the various embodiments are not limited in this respect. For example, any circuit capable of supporting a backhaul link (e.g., 5G or LTE) may be incorporated within network communication device 112. In some embodiments, network communication device 112 includes a subscriber identity module (SIM) that identifies network communication device to a backhaul link that connects to a radio access network (RAN) such as when the backhaul link circuit includes a 5G/LTE radio that connects to a RAN to form a backhaul link. These and other embodiments are described further below.

Network communication device 112 is also shown with Ethernet circuit 250B. In some embodiments, Ethernet circuit 250B provides connectivity inside a dwelling such as dwelling 240A (FIG. 2A). In some embodiments, Ethernet circuit 250B provides one or more twisted pairs of wires as a transmission medium such as transmission medium 222A. Ethernet circuit 250B is provided as an example of a circuit that can communicate across a transmission medium to provide broadband service to a customer within a dwelling. Various aspects described herein are not limited to Ethernet embodiments. For example, any type of circuit that can provide broadband communications between a network communication device and customer devices within a dwelling may be included within network communication device 112.

Network communication device 112 is also shown with power supply 260B. In some embodiments, power supply 260B is a switching power supply or linear power supply to power the various circuits within network communication device 112. Power supply 260B may accept power at any AC or DC voltage. For example, in some embodiments, power supply 260B may include a switching power supply that rectifies and filters 120 volts at 60 Hertz and produces appropriate voltages to power the remaining circuits within network communication device 112. In some embodiments, power supply 260B may also include a Power over Ethernet (PoE) circuit coupled to an Ethernet circuit 250B. In these embodiments, the Power over Ethernet circuit may extract power that is provided over an Ethernet cable coupled to Ethernet circuit 250B.

Network communication device 112 may also include a processing circuit, a memory, and other circuits. In some embodiments, the processing circuit may execute instructions that are stored in the memory and perform operations associated with the backhaul link circuit and the Wi-Fi access point. For example, a processing circuit may implement a scheduler such as scheduler 220B when executing instructions. These and other embodiments are described further below with reference to later figures.

Scheduler 220B schedules uplink data traffic and downlink data traffic on transmission medium 222A. For example, in embodiments in which transmission medium 222A is a time division duplex medium such as a twisted pair of wires, scheduler 220B may schedule a number of uplink packets and downlink packets, the timing of uplink packets and downlink packets, and a ratio of uplink packets and downlink packets.

In some embodiments, when a customer requests a speed test, scheduler 220B responds by modifying ratios of uplink packets to downlink packets for a predetermined period of time to ensure that the speed test reports a minimum contracted uplink data rate and a minimum contracted downlink data rate as expected by the customer. For example, in some embodiments, scheduler 220B may detect a speed test request made by a customer, determine that the speed test is a trigger for a modified action, and then proceed to modify a ratio of uplink data packets to downlink data packets for a predetermined period of time to ensure minimum uplink and downlink speeds are met.

In some embodiments, network communication device 112 may serve multiple dwellings, and transmission medium 222A may be part of a bundle of transmission mediums that may cause interference with each other. For example, transmission medium 222A may be an unshielded twisted pair of wires that is included in a bundle of multiple untwisted unshielded twisted pairs of wires. In some embodiments, scheduler 220B may not only alter data traffic patterns on transmission medium 222A servicing the customer that requested the speed test, but may also modify data traffic patterns on other transmission medium to reduce crosstalk and interference to ensure that the customer requesting the speed test experiences the desired result. These and other embodiments are described further below.

FIG. 2C is a block diagram illustrating an example, non-limiting embodiment of communication frames and subframes in accordance with various aspects described herein. FIG. 2C shows seven frames labeled FRAME 0, FRAME 1, FRAME 2, FRAME 3, FRAME 4, FRAME 5, and FRAME 6. Each frame includes subframes and each subframe includes communication data packets. For example, FRAME 2 is shown at 210C including 11 subframes. Any number of frames may be included and any number of subframes may be included within a frame in the various embodiments described herein.

FRAME 210C is shown having six uplink subframes that include uplink data packets and four downlink subframes that include downlink data packets. The number of uplink subframes and downlink subframes, and the corresponding number of uplink data packets and downlink data packets, may be modified by scheduler 220B (FIG. 2B). In some embodiments, scheduler 220B performs all scheduling of all frames and subframes. In other embodiments, scheduler 220B only schedules subframes when a trigger is satisfied. For example, a default schedule for uplink subframes and downlink subframes may be specified within the core network or elsewhere, and scheduler 220B may only modify the subframes and data packets when it determines that a trigger has been satisfied. For example, scheduler 220B may not modify any subframes or data packets during normal operation, and then may only modify the data traffic pattern when a trigger such as a speed test is recognized.

Frame 210C also shows a special subframe 220 C. In some embodiments, the special subframe is used to detect the speed test and to inform the scheduler that a speed test has been requested.

FIG. 2D is a table illustrating an example, non-limiting embodiment of ratios of uplink data packets and downlink data packets in accordance with various aspects described herein. Table 200D shows an example uplink data packet to downlink data packet ratio capable of providing greater than one gigabit/sec (GIG) uplink speed on a transmission medium capable of 1.2 GIG aggregate bandwidth. For example, a twisted pair of wires (either shielded or unshielded) may have an aggregate bandwidth available of 1.2 gigabits per second. As shown in table 200D, if a scheduler schedules 30 uplink data packets for every five downlink data packets, then greater than one gigabit per second uplink speed can be achieved as shown at 210D. Likewise, if the ratio were reversed such that there were 30 downlink data packets for every five uplink data packets, then the system is capable of showing greater than one gigabit per second downlink speed (not shown in FIG. 2D).

In the example of table 200D, a customer may have contracted with a service provider to have a minimum one gigabit per second uplink speed and a minimum one gigabit per second downlink speed even though the shielded pair of wires providing service to the customer is only capable of 1.2 gigabits per second aggregate bandwidth. In response to a customer satisfying a trigger such as requesting a speed test, the scheduler may modify the uplink data packet to downlink data packet ratio as shown in table 200D for a predetermined period of time so that the speed test results match the minimum guaranteed uplink speed and downlink speed as shown in FIG. 2D.

Although FIG. 2D shows a ratio of 30/5, this is not a limitation of the various embodiments. A scheduler may modify the ratio in any manner. For example, in some embodiments, a scheduler may schedule all packets as uplink packets for a predetermined period of time, or may schedule all packets as downlink packets for a predetermined period of time.

In some embodiments, a scheduler may modify data traffic on transmission media other than the transmission medium serving the customer that triggered the scheduler. For example, a scheduler may slow or stop data transmissions on twisted pairs of wires included in a common bundle with a twisted pair serving the customer that is requesting a speed test. Modifying this data traffic for other customers may include slowing transmission rates, stopping transmission for a predetermined period of time, or providing a buffer in a manner that reduces interference between twisted pairs of wires in a common bundle.

FIG. 2E is a block diagram illustrating an example, non-limiting embodiment of a network communication device providing broadband service to a multi-dwelling building in accordance with various aspects described herein. As shown in FIG. 2E, network communication device 112 may be located to provide broadband services to multiple broadband customers in a multi-dwelling building. For example, building 202E may be an apartment building or condominium complex that include dwellings 214E, 224E, 244E, and 234E, where each dwelling houses a broadband customer. Each of the dwellings within building 202E are shown with a single access point device. For example, dwelling 214E includes access point device 210E, dwelling 224E includes access point device 220E, dwelling 244E includes access point device 240E, and dwelling 234E includes access point device 230E. Each of the dwellings within building 202E and the associated access point devices may operate in accordance with the principles described above with reference to FIGS. 2A-2D.

In some embodiments, network communication device 112 may be physically located on the exterior of a multi-dwelling building such as shown in FIG. 2E where network communication device 112 is physically located on the exterior of building 202E. In some embodiments, network communication device 112 is located in a publicly accessible interior space of building 202E. In these embodiments, an installation technician may have access to the location at which network communication device 112 is installed without requiring physical access inside any particular dwelling unit.

In some embodiments, transmission media 212E, 222E, 232E, and 242E are shielded or unshielded twisted pairs included in a common bundle at or near network communication device 112. In these embodiments, communications on one of transmission media 212E, 222E, 232E, and 242E may interfere with communications on another of the transmission media. For example, if one customer is downloading data and a second customer is uploading data, or if multiple customers are uploading data or multiple customers are downloading data, radiating signals from one of the transmission media may provide interference to another thereby decreasing signal to noise ratio and potentially reducing apparent uplink and downlink speeds. In some embodiments, a scheduler included within network communication device 112 may schedule uplink subframes and downlink subframes and the corresponding uplink data packets and downlink data packets to manage interference between the various transmission media and also to guarantee any particular customer experiences a minimum level of service.

As an example, if a customer within dwelling 214E has a service level agreement (SLA) that guarantees a one gigabit per second upload speed and a one gigabit per second download speed, a speed test performed by the customer within dwelling 214E will report satisfactory uplink and downlink speeds even in the event that the aggregate bandwidth does not support the sum of the two speeds. In some embodiments, this is partly due to the operations of a scheduler within network communication device 112 which modifies the ratio of uplink data packets to downlink data packets for customer 214E for a predetermined period of time in response to determining that the speed test satisfies a trigger. Further, the scheduler within network communication device 112 may modify data traffic on any of media 222E, 232E, and 242E in order to ensure that the minimum service level agreement speeds for the customer within dwelling 214E are achieved. The data traffic for the other customers may be modified in any manner by the scheduler within network communication device 112. For example, in some embodiments, data traffic is halted completely for a predetermined period of time while a speed test is being performed by the customer within dwelling 214E. Also for example, in other embodiments, data rates are reduced for other customers.

FIG. 2F depicts an illustrative embodiment of a method 200F in accordance with various aspects described herein. At 210F, data traffic on a transmission medium is monitored. In some embodiments, this corresponds to a scheduler within a network communication device monitoring data traffic on a twisted pair of wires. In other embodiments, this corresponds to a scheduler monitoring data traffic on any time division duplex transmission medium. Time division duplex transmission media may be wired in some embodiments such as the twisted shielded pair example or may be a wireless medium. At 220F, a determination is made that a speed test has been requested by a customer. In some embodiments, this corresponds to inspecting packet headers to determine that a particular IP address or website has been accessed. The determination made at 220F may be made using any criteria and is not limited to determining an IP address or website.

At 230F, a ratio of upload data packets to download data packets is modified on the transmission medium for a predetermined period of time to ensure a minimum upload speed is achieved. In some embodiments, this corresponds to accessing a user account of a customer and determining that the speed test found at 220F satisfies a trigger that will modify a scheduler's behavior. In response to the speed test being found to be a trigger, the scheduler may modify the data traffic for a first period of time to ensure that a minimum uplink speed specified in a service level agreement with the customer is satisfied during a speed test. At 240F, the ratio of upload data packets to download data packets may be modified again on the transmission medium for a second predetermined period of time to ensure a minimum download speed is achieved. And some embodiments, this corresponds to increasing the number of download data packets relative to the number of upload data packets for the predetermined period of time to ensure that a download speed specified in a service level agreement for the customer is achieved as a result of the speed test. The predetermined period of time referenced at 230F and the predetermined period of time referenced at 240F may or may not be equal. For example, a scheduler may modify a ratio of upload data packets to download data packets at 230F to achieve an upload speed for one predetermined period of time, and at 240F may modify the ratio for a different predetermined period of time. In some embodiments, the predetermined period of time for the upload at 230F is shorter than the predetermined period of time for the download at 240F, and in other embodiments, the opposite is true.

At 250F, data traffic to customers other than the customer requesting the speed test may be modified. In some embodiments, this corresponds to reducing traffic on other transmission media that may cause interference to the transmission medium providing service to the customer that requested the speed test. For example, multiple customers may be served by a bundle of unshielded twisted pairs of wires and data traffic on one or more twisted pairs serving customers other than the customer requesting the speed test may be modified.

FIG. 2G depicts an illustrative embodiment of a method 200G in accordance with various aspects described herein. At 210G, a management interface is exposed to allow specification of upload and download speeds, time periods, and triggers. In some embodiments, this corresponds to a web portal that allows a properly authenticated manager to specify triggers, such as a speed test, and minimum guaranteed upload and download speeds. The management interface may also allow specification of predetermined time periods for which a scheduler will modify uplink data packets and downlink data packets during an event that triggered scheduler behavior.

At 220G, ratios of upload data packets and download data packets are modified in response to the triggers. In some embodiments, this corresponds to modifying a ratio of upload data packets to download data packets for a first predetermined period of time to ensure that a customer experiences a minimum agreed upon upload speed and download speed as described above. At 230G, data traffic patterns in bundles of twisted pair wires are modified to achieve upload and download speeds in response to the triggers. In some embodiments, this corresponds to slowing or stopping data traffic in twisted pairs of wires that are in a in a bundle common to the twisted pair serving the customer that has requested the speed test.

While for purposes of simplicity of explanation, the respective processes are shown and described as a series of blocks in FIGS. 2F and 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

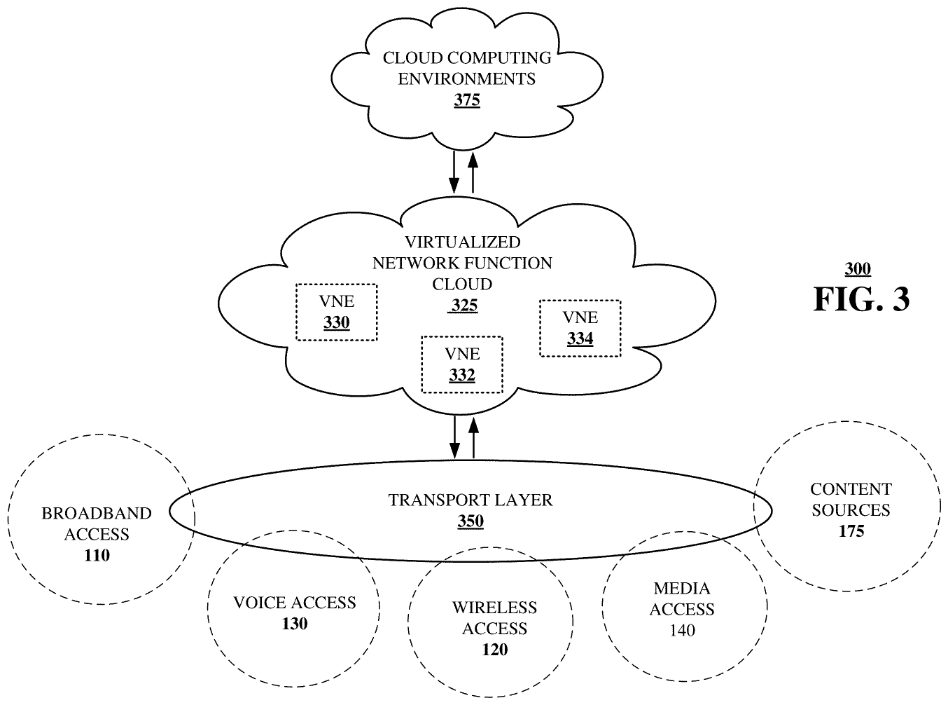

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of systems and methods presented in FIGS. 1, 2A-2G. For example, virtualized communication network 300 can facilitate in whole or in part modifying ratios of upload packets to download packets in response to request for a speed test.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

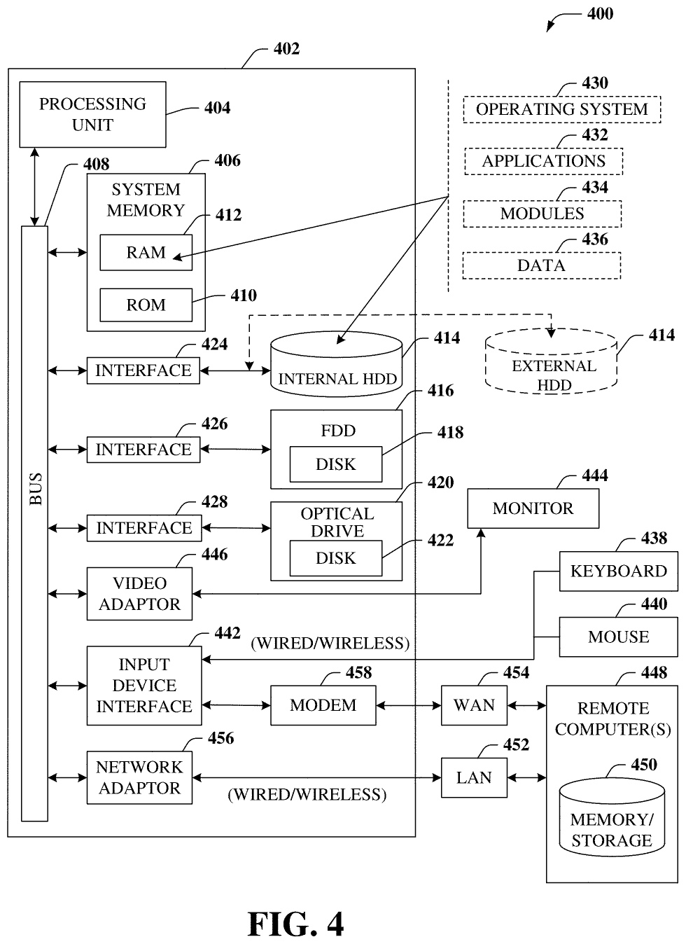

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part modifying ratios of upload packets to download packets in response to request for a speed test.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, ax, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

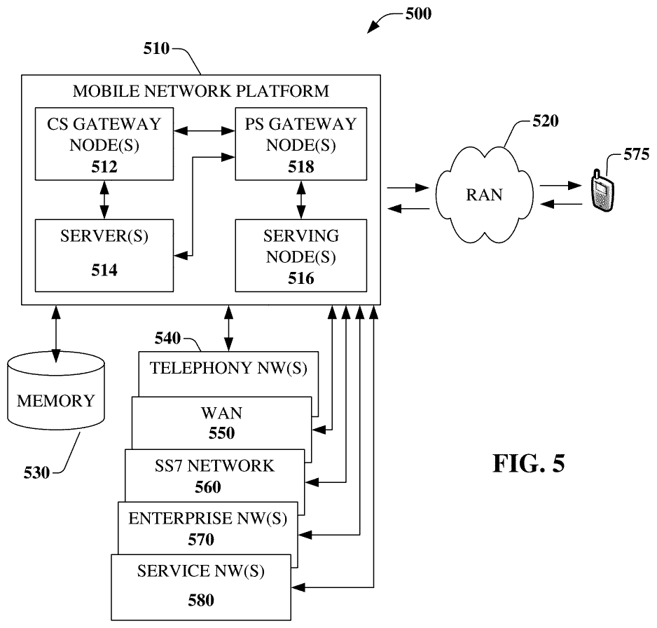

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part modifying ratios of upload packets to download packets in response to request for a speed test. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

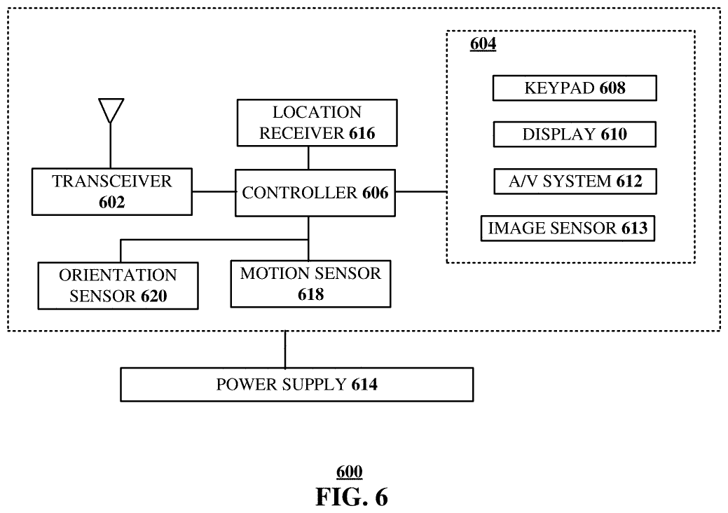

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part modifying ratios of upload packets to download packets in response to request for a speed test.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
monitoring data traffic on a transmission medium;
in response to the monitoring, determining that a speed test has been requested; and
in response to the determining that the speed test has been requested, modifying a ratio of upload data packets on the transmission medium to download data packets on the transmission medium for a predetermined period of time to ensure a minimum upload speed is achieved.

2. The device of claim 1, wherein the transmission medium comprises a first twisted pair of wires.

3. The device of claim 2, wherein the first twisted pair of wires is unshielded.

4. The device of claim 2, wherein the transmission medium comprises a plurality of twisted pairs of wires, wherein the first twisted pair of wires is one of the plurality of twisted pair of wires.

5. The device of claim 4, wherein the operations further comprise modifying data traffic on at least one of the plurality of the twisted pairs of wires other than the first twisted pair of wires during the predetermined period of time to reduce signal interference between the at least one of the plurality of the twisted pairs of wires and the first twisted pairs of wires.

6. The device of claim 1, wherein the transmission medium comprises a wireless medium.

7. The device of claim 1, wherein the monitoring comprises monitoring contents of headers of packets on the transmission medium.

8. The device of claim 1, wherein modifying the ratio comprises:
retrieving a stored time value specifying the predetermined period of time; and
modifying the ratio based on the time value.

9. The device of claim 1, wherein the operations further comprise further modifying the ratio of the upload data packets on the transmission medium to the download data packets on the transmission medium for a second predetermined period of time to ensure a minimum download speed is achieved.

10. The device of claim 9, wherein the predetermined period of time is equal to the second predetermined period of time.

11. A non-transitory machine-readable medium, comprising executable instructions that, when executed by a processing system including a processor, facilitate performance of operations, the operations comprising:
monitoring data traffic on a transmission medium;
in response to the monitoring, determining that a speed test has been requested; and
in response to the determining that the speed test has been requested modifying a ratio of upload data packets on the transmission medium to download data packets on the transmission medium for a predetermined period of time to ensure a minimum upload speed is achieved.

12. The non-transitory machine-readable medium of claim 11, wherein the transmission medium comprises a first twisted pair of wires.

13. The non-transitory machine-readable medium of claim 12, wherein the first twisted pair of wires is unshielded.

14. The non-transitory machine-readable medium of claim 12, wherein the transmission medium comprises a plurality of twisted pairs of wires, wherein the first twisted pair of wires is one of the plurality of twisted pair of wires.

15. The non-transitory machine-readable medium of claim 14, wherein the operations further comprise modifying data traffic on at least one of the plurality of the twisted pairs of wires other than the first twisted pair of wires during the predetermined period of time to reduce signal interference between the at least one of the plurality of the twisted pairs of wires and the first twisted pairs of wires.

16. A method comprising swinging sub-frame assignments of time division duplex (TDD) splits to dynamically modify a ratio of uplink data packets and downlink data packets with short spacing gap and short reaction time between two symbols by assigning a time scheduler to frames.

17. The method of claim 16 further comprising providing manual management of the time scheduler handling by assigning a predetermined time to uplink TDD symbols to achieve symmetric uplink and downlink speeds.

18. The method of claim 16 wherein the time scheduler allows symbols to achieve a desired uplink speed for a predetermined period of time based on a user data traffic transaction.

19. The method of claim 18 further comprising returning the ratio of uplink data packets to downlink data packets to a value that existed prior to the assigning the time scheduler to the frames, wherein the further modifying is performed after the predetermined period of time.

20. The method of claim 19 wherein the predetermined period of time is specified by an operator via an application programming interface (API).
